(19) United States
(12) Patent Application Publication
(10) Pub. No.: US 2020/0392787 A1
(43) Pub. Date: Dec. 17, 2020

(54) DEPLOYABLE DEVICE, IN PARTICULAR STEP STOOL

(71) Applicant: NA-CEO FRANCE, MONTBÉLIARD (FR)

(72) Inventor: David NAVARRO, MONTBÉLIARD (FR)

(21) Appl. No.: 16/771,292

(22) PCT Filed: Dec. 10, 2018
(86) PCT No.: PCT/EP2018/084097

§ 371 Date: Jun. 10, 2020

(30) Foreign Application Priority Data
Dec. 14, 2017 (FR) 1771362

(51) Int. Cl. E06C 1/00; A47B 77/10

(52) U.S. Cl. CPC E06C 1/005; A47B 77/10

(57) ABSTRACT

A device that can be deployed from a retracted position to a deployed position comprises at least a first board and a second board, the device comprising a base frame intended to be horizontal and a deployment mechanism for guiding the boards between the retracted position and the deployed position, and vice versa, the first board being offset towards the rear of the device relative to the second board in a horizontal main direction when the device is in the deployed position and, when the device is in the retracted position, the first board is offset towards the front of the device and the second board is offset towards the rear, the two boards being situated at substantially the same level.

### FIELD OF THE INVENTION

The invention relates to a deployable device comprising different boards, in particular a step stool.

### STATE OF THE ART

In a home, company or shop, it is common to have items of furniture of great height and width, containing very deep storage spaces. Stowing away or accessing objects placed in the rear part of these storage spaces is difficult. It is difficult to reach storage spaces that are situated inside the piece of furniture at a great height. This is also the case for deep drawers whose extraction travel is limited.

An item of furniture is known in the prior art which comprises a base fitted with a drawer, and a folding step stool assembly contained in the drawer. The step stool assembly is configured to be extracted from the drawer and to rise into an unfolded position to form a step stool with two steps when the drawer is open. It is known that the deployment of the step stool assembly is activated by pressing on a first control device placed at the front of the drawer. It is known that the drawer opens and slides automatically by means of a translational guiding mechanism, and that a means of starting the translation movement brings the step stool assembly out of the drawer; this means is either a spring or a motor. Once the drawer is open, a second control device activates the rotation of a spring or a motor which causes the step stool to deploy vertically.

However, this solution has the disadvantage that the two steps are stacked one on top of the other when they are stowed in the drawer, and when they are deployed, the two steps remain partially one above the other. This has the drawback of reducing the area available for the user to place their feet on the board forming the step due to the interference of the upper step, making it relatively unsafe to climb on this step stool, and limiting the number of steps. In fact, the number of steps depends on the capacity to stack them inside the drawer, which has to fit under a cabinet. The low stowage height under the cabinet, commonly less than 10 centimetres, in some cases less than 7 centimetres, only allows for a few steps. This solution is not suited to the construction of storage spaces such as compartments forming stacking drawers instead of steps. Indeed, such compartments forming drawers which stack on top of each other when they are in the stowed position will have a low height due to their stacking, thereby limiting their use as drawers, and will not allow access to the back of the storage or make compartments forming satisfactory drawers. This solution is also not suited to the construction of storage spaces such as shelves. In fact, exactly like steps, the shelves remain partially overlapping. This has the drawback of reducing the area of the board available to store objects due to the interference of the upper shelves which encroach on the area of the shelves directly below them. The known solutions do not provide a satisfactory response for these different applications.

Thanks to patent EP 1366692 A2 a retractable folding stool is known with at least one step, which is lodged in the closed position underneath a cabinet. It is extracted from underneath the cabinet by means of a structure comprising a first horizontal pantograph activated by gas springs. This device also includes spring bolts allowing it to be maintained in the closed position; the stool is deployed by a mechanism corresponding to a second vertical pantograph moved by gas springs. This solution has the same disadvantage for the construction of a step stool, or the transposition to the construction of drawers or shelves, that of having two steps one above the other as in the previous example from the prior art.

### OBJECTIVES OF THE INVENTION

It is therefore an objective of this invention to propose a device that overcomes these failings of the prior art by allowing the user easier access either to steps or to compartments forming drawers or to shelves when the device is deployed, whilst allowing the device to be satisfactorily stowed in a storage space, in particular one of limited height.

### DESCRIPTION OF THE INVENTION

With these objectives in mind, the subject matter of the invention is a device deployable from a retracted position to a deployed position, comprising at least a first board and a second board, the first and the second board extending into the deployed position respectively in a first horizontal plane and a second horizontal plane, the two planes being offset from each other, said device comprising a base frame designed to be horizontal and a deployment mechanism comprising two subassemblies on either side of the boards to guide the boards between the retracted position and the deployed position, and vice versa, the first board being offset towards the rear of the device relative to the second board in a horizontal main direction when the device is in the deployed position, characterised in that when the device is in the retracted position, the first board is offset towards the front of the device and the second board is offset rearwardly, the two boards being situated at substantially the same level and parallel to the first and the second plane, the base frame being detached, fixed or connected to a surrounding structure by at least one horizontally extending telescopic arm.

“At the same level” is to be understood as a position at a similar height, measured on a vertical axis, that is to say perpendicular to the first and second planes. The device in the retracted position is compact and can be stowed in a small space, in particular one of low height. It may be entirely mobile or attached telescopically to a surrounding structure, such as a drawer for example. The offset between the boards in the retracted position means that they can be stowed without being placed on top of each other, therefore optimising the height required. In addition, the inversion of their placement between the deployed position and the retracted position means that their trajectory remains substantially within the space occupied by the base frame, thereby facilitating deployment without interfering with surrounding objects. The boards can be steps so that the device forms a step stool. They can also be trays so that the device forms a storage and presentation installation. The base frame can be fixed onto the top of a piece of furniture, fixed or mobile, or on the bottom for deployment downwards. It can also simply be free-standing so that it can be placed on the floor.

According to one construction arrangement, each subassembly comprises a main bar mounted pivotably on the base frame towards the rear, a first support bar to support the first board and mounted pivotably at the top end of the main bar, a first link bar mounted pivotably also at the top end of the main bar, and a second link bar in alignment with the first link bar in the deployed position and mounted pivotably on the base frame towards the front. The main bar forms a triangle with the base frame and with the first and the second link bars when the latter are aligned in the deployed position, whilst when the first and the second link bars are folded back on themselves, in the retracted position, the main bar is folded down along the base frame, horizontally. The deployment of the first board is therefore achieved simply by a pivoting guide.

According to a particular arrangement, in the deployed position, the pivot axis of the first link bar on the second link bar is offset towards the pivot axis of the main bar on the base frame relative to the segment formed by the pivot axes of the first link bar on the main bar and of the second link bar on the base frame. This avoids reaching a position in which the pivot axes are in the same plane, which would cause a complete blocking of the folding mechanism. With this arrangement, exerting pressure on the main bar enables the link bars to be folded on themselves, which facilitates the movement into the folded position.

In a complementary manner, the subassembly further comprises a second support bar to support the second board, parallel to the first support bar and mounted pivotably on the first link bar on the same axis as the second link bar, and a third link bar parallel to the first link bar and linked pivotably to the first and the second support bars, so that the pivot axes of the first and the third link bars are positioned in the top corners of a first parallelogram. This guarantees the parallelism between the support bars, and therefore between the boards, as well as the synchronisation of their deployment.

In a complementary manner, the subassembly further comprises a fourth link bar parallel to the second link bar and linked pivotably to the second support bar and to the base frame so that the pivot axes of the second and the fourth link bars are positioned in the top corners of a second parallelogram. This guarantees the parallelism of the support bars, and therefore the boards, with the base frame.

In a first embodiment, the subassembly further comprises a retainer bar mounted pivotably on the second support bar at one end and mounted slidably and pivotably at the second end on the base frame in the horizontal main direction so as to form a blocking strut for the second support bar in the deployed position by being close to vertical. The retainer bar provides considerable rigidity to the deployment mechanism, absorbing the vertical loads due to the weight placed on the boards. The retainer bar guarantees the device in the deployed position against the stresses exerted on the surfaces.

According to one construction arrangement, the retainer bar is connected to a first gas spring connected to the base frame and serving to move the sliding end of the retainer bar towards the blocking strut position. The first gas spring contributes to the deployment of the device, in particular during the phase leading up to the achievement of the deployed position. In fact, the retainer bar contributes to the alignment of the third and fourth link bars, and therefore of the first and second link bars.

In a complementary manner, the retainer bar comprises a pivot pin guided in a runner on the base frame, said runner comprising a notch in which the pivot pin is lodged in the deployed position by a downward movement of the retainer bar, so that it prevents the pivot pin sliding in the runner when there is a load on one or other of the boards. When the pivot pin is lodged in the notch, the retainer bar can no longer pivot, thereby guaranteeing that the subassembly in the deployed position is blocked in position.

In a complementary manner, the first gas spring includes blocking means to block the rod of the first gas spring in the extended position and prevent the pivot pin sliding in the runner in the deployed position, and tensioning means that push the retainer bar upwards. The tensioning means may be, for example, a mechanical spring acting on the first gas spring to make it rotate, or on the pivot pin by accompanying its travel. Thus, the blocking of the first spring guarantees that the pivot pin slots into the notch when there is a load on the boards, by a slight downward movement of the retainer bar against the tensioning means. The blocking means can be controlled remotely. When they are released, the load on the boards tends to compress the gas spring and make the rod retract, so that the pivot pin slides in the runner without engaging in the notch and allows the device to return to the retracted position. This movement is accompanied by the tensioning means which prevent the pivot pin engaging in the notch.

In one construction arrangement, the parts of a subassembly of the deployment mechanism are arranged in a transverse direction, that is to say horizontally and perpendicular to the main direction, as follows, from the outside inwards:
the main bar;
the first support bar;
the third link bar;
the first link bar;
the second link bar, mounted pivotably on the outside of a vertical flange on the base frame;
the second support bar;
the fourth link bar, mounted pivotably on the inside of the vertical flange on the base frame.

This arrangement guarantees that the parts of the subassembly can be stowed next to each other in the closed position, so that the height taken up in this position is as limited as possible.

In a complementary manner, the retainer bar is placed after the fourth link bar.

According to one construction arrangement, each subassembly includes a second gas spring connecting the base frame and the main bar and serving to place the device in the deployed position. This type of spring, comprising a tubular body and a rod sliding in the tubular body forming an actuator, serves to extend the rod under the effect of a compressed gas. It also dampens the movement. The rod and the body are mounted pivotably or on a ball joint on the base frame and the main bar respectively.

According to a particular arrangement, the second gas spring is connected to the main bar close to the top end of the main bar.

According to an improvement, the main bar includes a first heel extending the main bar beyond the pivot axis on the base frame so that the first heel protrudes underneath the base frame when the device is in the deployed position to rest on the floor, and retracts in the retracted position. The deployment of the device causes the heel to emerge underneath the base frame so that the device is held on the floor and prevented from moving and therefore acquires a stable position.

In a complementary manner or alternatively, the second link bar comprises a second heel extending the second link bar beyond the pivot axis on the base frame so that the second heel protrudes underneath the base frame when the device is in the deployed position to rest on the floor, and retracts in the retracted position. The same function as before can also be achieved in this way, in addition or alone.

In a second embodiment, each subassembly comprises a locking mechanism arranged to link together, in the deployed position and in the retracted position, the first and second link bars or the third and fourth link bars. This locking mechanism replaces the function of the retainer bar by linking together the first and second link bars so that this assembly, with the base frame and the main bar, forms a rigid triangle, or, in the case of the assembly formed by the third and fourth link bars, rigidifies the first and the second parallelogram.

According to one construction arrangement, the locking mechanism comprises a body fixed onto one of the first or second link bars, the other link bar comprising an arm extending said link bar beyond the pivot axis between the two link bars, said locking mechanism further comprising a latch bolt mounted slidingly and elastically in the body and arranged to cooperate with a first strike plate on the arm and a second strike plate on the other link bar opposite the first strike plate relative to said pivot axis.

Alternatively, the device comprises a stop mechanism arranged to link together the second or first board and the base frame in the retracted position. Thus, the device is only deployed when the stop mechanism is released and is otherwise maintained in the retracted position, even when the device is moved.

According to one improvement, the locking or stop mechanism respectively, is controlled remotely by an actuating member. The actuating member may be a pedal or a turn or pull-type handle. It may be monostable or bistable, which is to say that it has one or two stable positions.

According to an improvement, the base frame comprises swivel castors and, at the rear, abutment means extending substantially vertically and transversely, said abutment means being capable of engaging with a guide limb fixed onto a surrounding structure to hold the device in the main direction and guide it transversely. The device can thus be moved on its castors to the position in which the abutment means come into contact with the guide limb, then moved transversely along said guide limb. This configuration is of particular interest when the device is stowed underneath a cabinet that is part of a row of cabinets, from where it is extracted and slid along the row as far as the required cabinet to place it in the position where it is intended to use the device.

According to one improvement, the abutment means are retractable. The device can therefore be freed completely.

In another complementary arrangement, the base frame comprises castors on which the device can be moved, said castors being retractable so that the device rests on the floor on fixed pads when a weight is resting on the device. Thus, the device can be moved easily, especially if the castors are swivel castors, when it is not loaded, and can rest on the pads, which may, for example, be adherent, when a person climbs on the device, thereby rendering the loaded device completely stable.

### BRIEF DESCRIPTION OF THE FIGURES

Other advantages may still appear to a person skilled in the art on reading the examples below, illustrated by the attached figures, provided for illustrative purposes, which include:

FIGS. 1 and 2 are perspective views of a device consistent with a first embodiment of the invention, in the deployed and retracted positions respectively;

FIGS. 3 and 4 are lateral cross-sectional views of the device shown in the FIG. 1 stowed under a cabinet and out of the housing respectively;

FIGS. 5 and 6 are close-ups of detail V in the FIG. 3 showing stop means in the locked and released positions respectively;

FIG. 7 is a schematic top view of the arrangement of the parts of a subassembly of the deployment mechanism, seen in the retracted position;

FIG. 8 is a close-up of detail VIII in FIG. 1 showing an actuating member, in the actuated position;

FIG. 9 is a side view of the device shown in FIG. 1 in an intermediate position between the retracted position and the deployed position;

FIG. 10 is a close-up of detail X in FIG. 9;

FIGS. 11 to 14 are views similar to FIGS. 9 and 10 in a deployed and locked position respectively;

FIG. 15 is a similar view to FIG. 1 showing a second embodiment of the invention;

FIG. 16 is a similar view to FIG. 1 showing a third embodiment of the invention;

FIGS. 17 and 19 to 22 are side or perspective views of the device shown in FIG. 16, respectively in the retracted position and held against the surrounding structure, in the retracted position and free of the surrounding structure, in the deployed position and held against the surrounding structure, in the retracted position and away from the surrounding structure, and in the deployed position and free of the surrounding structure;

FIG. 18 is a close-up of detail XVIII in FIG. 17;

FIG. 23 is a perspective view of the device shown in FIG. 16 in the deployed position and held against the surrounding structure;

FIG. 24 is a lightly sloping top view of the device shown in FIG. 16 in the deployed position;

FIGS. 25 and 26 are close-ups of detail XXV in FIG. 24, in the locked and unlocked positions respectively;

FIG. 27 is a side view of another embodiment of the device in the deployed position.

### DETAILED DESCRIPTION

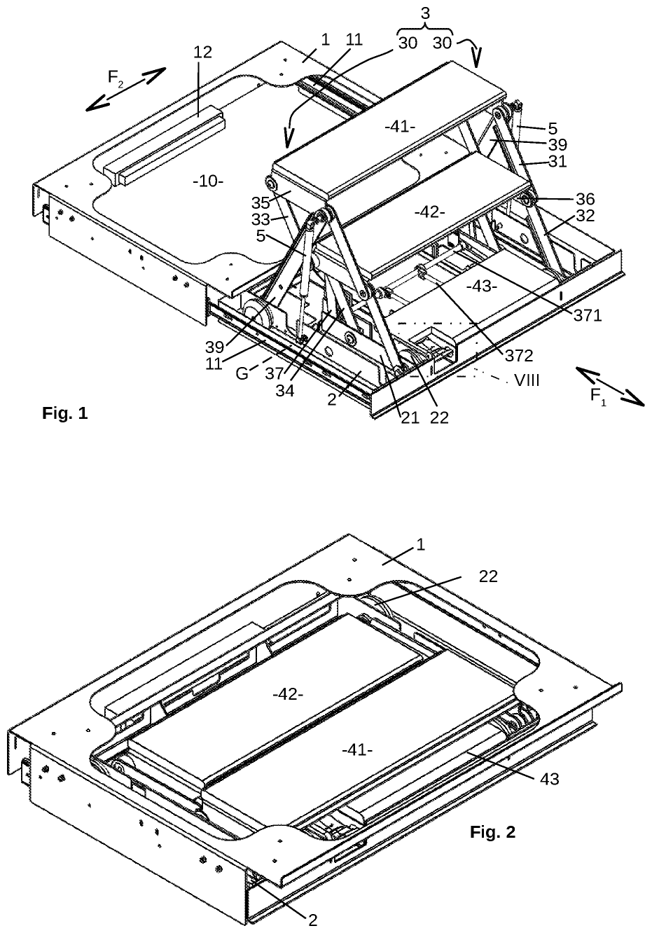

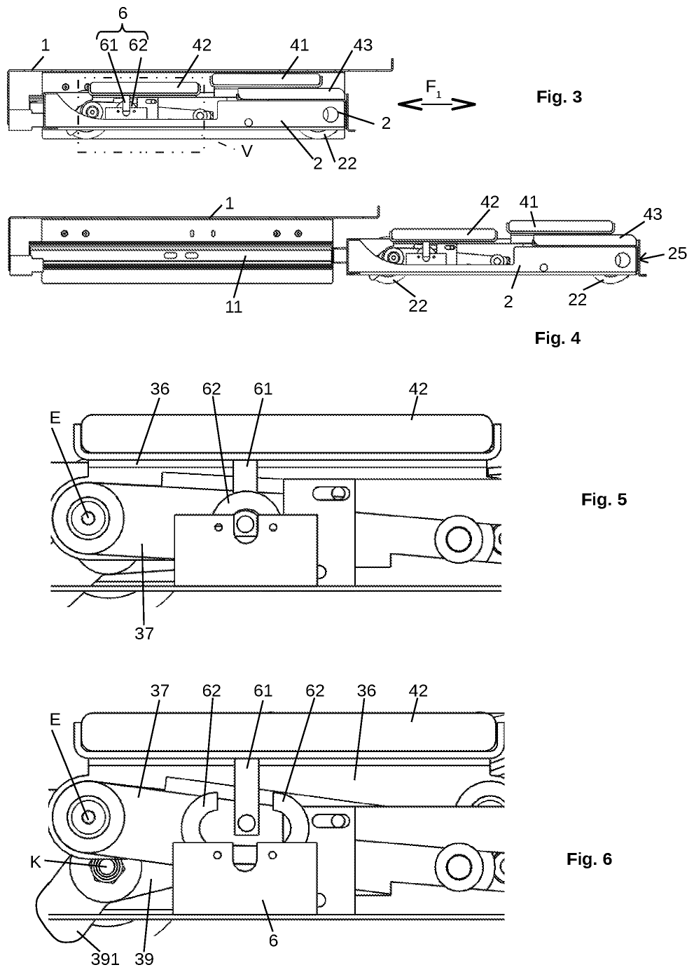

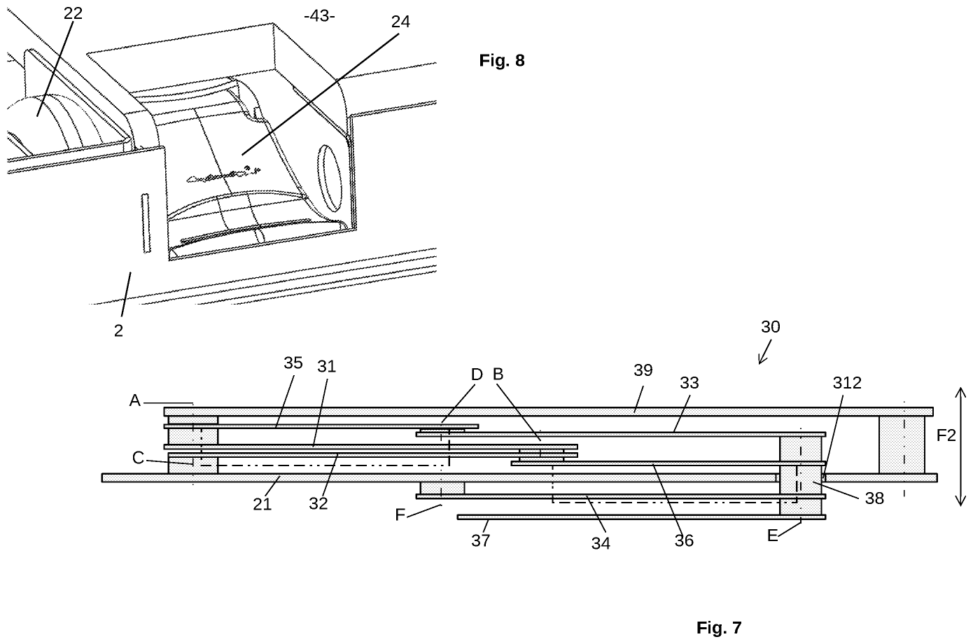

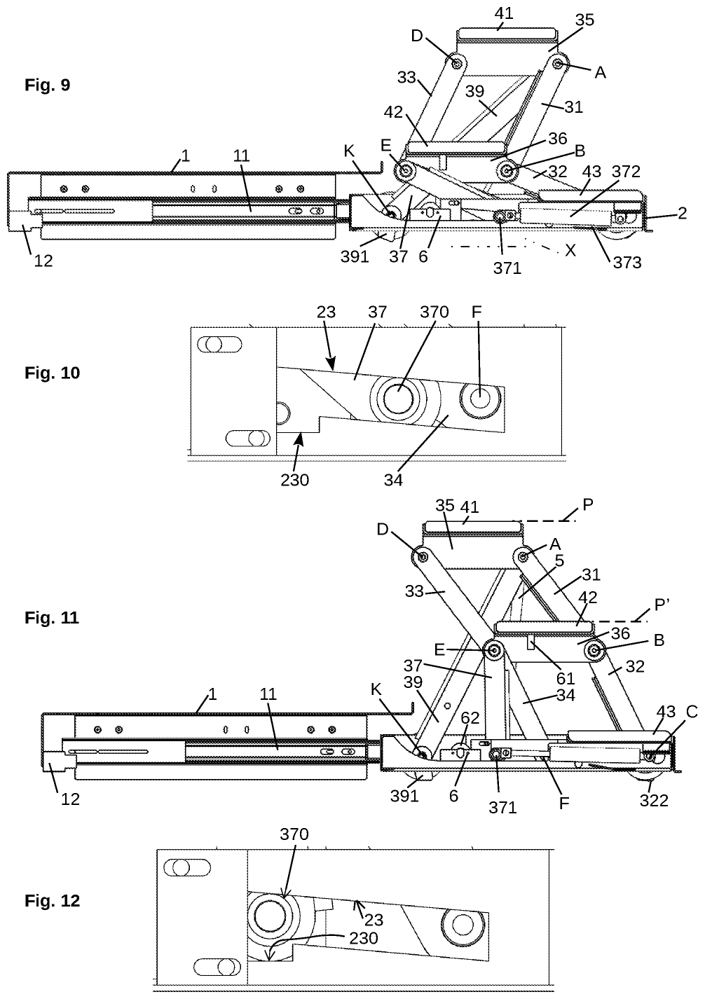

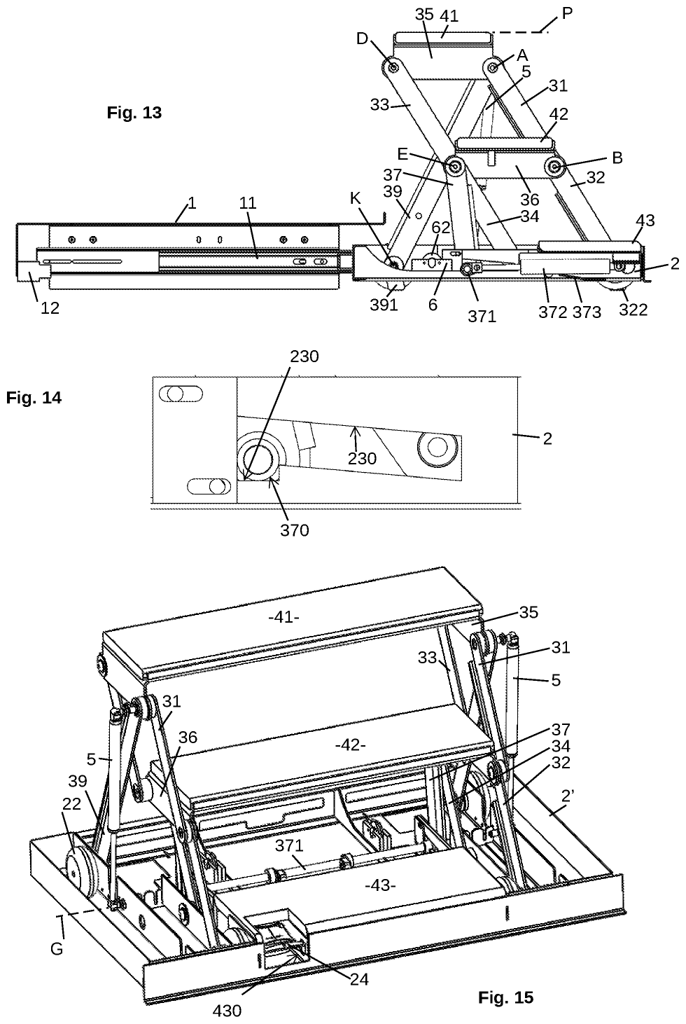

In a first embodiment, a device according to the invention, shown in FIGS. 1 to 13, can be deployed from a retracted position as shown in FIGS. 2 and 3, to a deployed position, as shown in FIGS. 1 and 13. In this embodiment, the device is a step stool comprising three steps 41, 42, 43 to enable the user to access storage high cupboards. The device comprises a casing 1 forming a surrounding structure and delimiting a housing 10, a base frame 2 and two horizontally extending telescopic arms 11 to connect the casing 1 to the base frame 2. The telescopic arm 11 comprises at least two parts sliding relative to each other, one of which is fixed to the casing 1 while the other is fixed onto the base frame 2 of the device. The base frame 2 is fitted with castors 22, enabling the device to be moved from a position stowed inside the housing 10, as shown in FIG. 3, to a position out of the housing, as shown in FIG. 4, it being guided by the telescopic arms 11 in a horizontal main direction F1. The casing 1 is designed to be fixed onto the bottom of a piece of furniture. In an alternative version not shown, the telescopic arms 11 could be fixed directly onto the surrounding structure consisting of the piece of furniture.

Extraction from the housing 10 is facilitated by release pistons 12 fastened onto the casing 1 in the back of the housing 10. Such a piston 12 comprises a rod which is caused to extend outwards under the effect of a spring. When the device moves into the stowed position, it drives said rod and compresses the spring. Once in the stop position, the piston comprises a mechanism that maintains the rod retracted. Renewed pressure towards the stop position operates the mechanism, which then releases the rod, which pushes the device forwards under the effect of the spring, making the device accessible so that it can be moved into position outside the housing.

Two of the steps consist of a first board 41 and a second board 42, the first and the second board 41, 42 extending into the deployed position in a first horizontal plane P and a second horizontal plane P′ respectively, the two planes being offset from each other. The base frame 2 is designed to be horizontal. The device comprises a deployment mechanism 3 consisting of two subassemblies 30 on either side of the boards 41, 42 to guide the boards between the retracted position and the deployed position, and vice versa. The first board 41 is offset towards the rear of the device relative to the second board 42 in the horizontal main direction when the device is in the deployed position and, when the device is in the retracted position, the first board 41 is offset towards the front of the device and the second board 42 is offset rearwardly, the two boards 41, 42 being situated at substantially the same level.

Each subassembly 30 comprises bars mounted pivotably along horizontal transverse axes. Each subassembly 30 comprises a main bar 39 mounted pivotably at K on the base frame 2 towards the rear, a first support bar 35 to support the first board 41 and mounted pivotably at A at the top end of the main bar 39, a first link bar 31 mounted pivotably also at A at the top end of the main bar 39, and a second link bar 32 in alignment with the first link bar 31 in the deployed position and mounted pivotably at C on the base frame 2 towards the front.

The subassembly 30 further comprises a second support bar 36 to support the second board 42, parallel to the first support bar 35 and mounted pivotably on the first link bar 31 on the same axis B as the second link bar 32, and a third link bar 33 parallel to the first link bar 31 and linked pivotably at D and E to the first and the second support bars 35, 36, so that the pivot axes of the first and the third link bars 31, 33 are positioned in the corners of a first parallelogram ABED.

The subassembly 30 further comprises a fourth link bar 34 parallel to the second link bar 32 and linked pivotably at E to the second support bar 36 and at F to the base frame 2 so that the pivot axes of the second and the fourth link bars 34 are positioned in the top corners of a second parallelogram BCFE.

The parts of each subassembly 30 of the deployment mechanism 3 are arranged in a transverse direction F2, that is to say horizontally and perpendicular to the main direction F1, as follows, from the outside inwards:
the main bar 39;
the first support bar 35;
the third link bar 33;
the first link bar 31;
the second link bar 32, mounted pivotably on the outside of a vertical flange 21 on the base frame 2;
the second support bar 36;
the fourth link bar 34, mounted pivotably on the inside of the vertical flange 21 on the base frame 2;
a retainer bar 37.

The vertical flange 21 comprises a recess 312 to accommodate the pivot pin 38 linking the fourth link bar 34 to the second support bar 36. In the folded position, all the pivot axes of the deployment mechanism are substantially in the same horizontal plane.

The retainer bar 37 is mounted pivotably at E on the second support bar 36 at one end and mounted slidably and pivotably at the second end on the base frame 2 in the horizontal main direction so as to form a blocking strut for the second support bar 36 in the deployed position by being close to vertical. The retainer bar 37 comprises a pivot pin 370 guided in a runner 23 on the base frame 2 extending substantially in the main direction. The runner 23 comprises a notch 230 in which the pivot pin 370 is lodged in the deployed position by a downward movement of the retainer bar 37, so that it prevents the pivot pin 370 sliding in the runner 23 when there is a load on one or other of the boards 41, 42. The pivot pins 370 of the retainer bars 37 are connected to each other by a cross member 371, and the cross member 371 is connected to two first gas springs 372 connected to the base frame 2 and serving to move the cross member 371 rearwards in the main direction and therefore to move the retainer bar 37 towards the blocking strut position.

The first gas springs 372 comprise blocking means, known as such, to block the rod of the first gas spring 372 in the extended position and prevent the pivot pins 370 sliding in the runners 23 in the deployed position. The blocking means are remotely controlled by a pedal 24 mounted on the base frame along the front edge 25 and accessible to the user. Tensioning means are also provided which push the retainer bar 37 upwards so that they tend to push the pivot pin 370 away from the notch 230. The tensioning means may consist for example of a leaf spring 373 pushing the body of the first gas spring 372.

Each subassembly 30 further comprises a second gas spring 5 connecting the base frame 2 and the main bar 39 near the top end of the main bar 39 to move the device into the deployed position. The second gas spring 5 is mounted pivotably firstly at A, the pivot axis of the first support bar 35 on the main bar 39 and, secondly, at G on the base frame 2, away from the pivot axis of the main bar 39 on the base frame 2 by approximately one third to half the distance between the pivot axis K of the main bar 39 and the pivot axis A of the first support bar 35. In addition, the height of the pivot axis G of the second spring on the base frame 2 is chosen so that even in the retracted position, the second spring is not aligned with the main bar 39 so that there remains some force to deploy the device. This force is countered in the retracted position by a stop mechanism 6 arranged to link together the second board 42 and the base frame 2. To achieve this, the second board 42 comprises a hook 61 protruding downwards. The stop mechanism 6 comprises two jaws 62 which are spaced apart in the unlocked position and which pivot to grip the hook 61 when it is placed between the jaws 62 and comes to press on the stop mechanism 6. Pressing down again opens the jaws 62. These functions of the stop mechanism 6 being known, they are not described here in more detail.

In addition, the main bar 39 comprises a first heel 391 extending the main bar 39 beyond the pivot axis on the base frame 2 so that the first heel 391 protrudes underneath the base frame 2 when the device is in the deployed position to rest on the floor, and retracts in the retracted position. Likewise, the second link bar 32 comprises a second heel 322 extending the second link bar 32 beyond the pivot axis on the base frame 2 so that the second heel 322 protrudes underneath the base frame 2 when the device is in the deployed position to rest on the floor, and retracts in the retracted position. In a version shown in FIG. 27, the first and the second heels 391, 322 do not act directly on the floor, but by means of a shoe 26. The shoe 26 is mounted slidingly on the base frame 2′″ and is controlled by the heels 391, 322, or articulated on the heels around a horizontal axis in such a way as to raise the castors off the ground when the device is in the deployed position. The shoe 26 comprises a flat surface designed to rest on the floor, wide enough not to mark said floor. The surface is preferentially coated with an elastomer in order to optimise adherence and reduce the risk of marking the floor.

The base frame 2 comprises a third board 43 fixed horizontally at the front. The third board 43 comprises a cut-out 430 so that the pedal 24 is accessible.

When using the device from the retracted position with the base frame 2 stowed inside the housing 10, the user pushes on the front edge 25 of the base frame 2 so that the release pistons 12 are activated and release the base frame 2, which moves forward. The user helps to extract the base frame 2 completely from the housing 10.

Then, when the base frame 2 is free of the housing 10, the user presses on the second board 42 thereby activating the stop mechanism 6 to release the hook 61. Under the combined effect of the first and second gas springs 372, 5, the main bars 39 pivot upwards at K, causing the first board 41 to rise at the same time as it moves rearwards. The combination of the parallelograms guides the first board 41 so that it remains horizontal during the movement and when it arrives in the deployed position, whilst also guiding the second board 42, which passes forward from behind to a position substantially mid-way between the first and the third board 41, 43. During this movement, the first and the second heels 391, 322 come into contact with the floor and raise the base frame 2. The castors 22 are then raised off the floor and the device rests stably on the floor. Also during this movement, the cross member 371 moves rearwards under the effect of the first gas springs 372, pushing the retainer bars 37 until they are almost in a vertical position.

The thrust exerted by the retainer bars 37 under the combined effect of the first springs 372 and the tensioning means 373 acts on the second board 42, propelling it forward until the first and second link bars 31, 32 are no longer aligned, as shown in FIG. 11. The deployed position is then reached. The user then operates the pedal 24 which when depressed activates the locking of the first gas springs 372. This low position is stable.

When the user steps on the second board 42, he exerts with his weight a force on the retainer bar 37 against the action of the first springs and tensioning means 373. The retainer bar 37 starts to move downwards, but as the first springs 372 are blocked, the pivot pin 370 of the retainer bar 37 engages in the notch 230, which locks the device in the deployed position, as shown in FIGS. 13 and 14. The retracted position is reached by an opposite movement, after unlocking the first gas springs 372 and lifting the pedal 24.

In a second embodiment, shown in FIG. 15, the device differs from that of the first embodiment in that the base frame 2′ is free, that is to say not connected to the surrounding structure by the telescopic arms. Such a device may be used freely then stowed away in a low-height space.

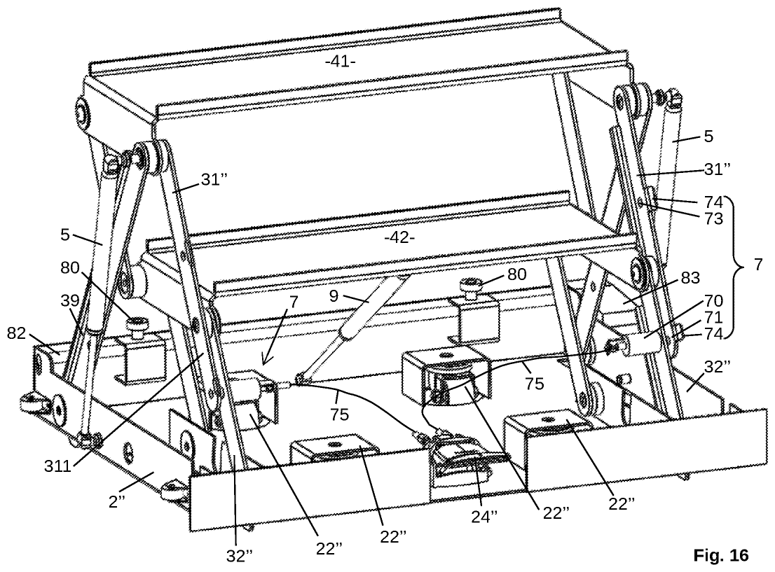

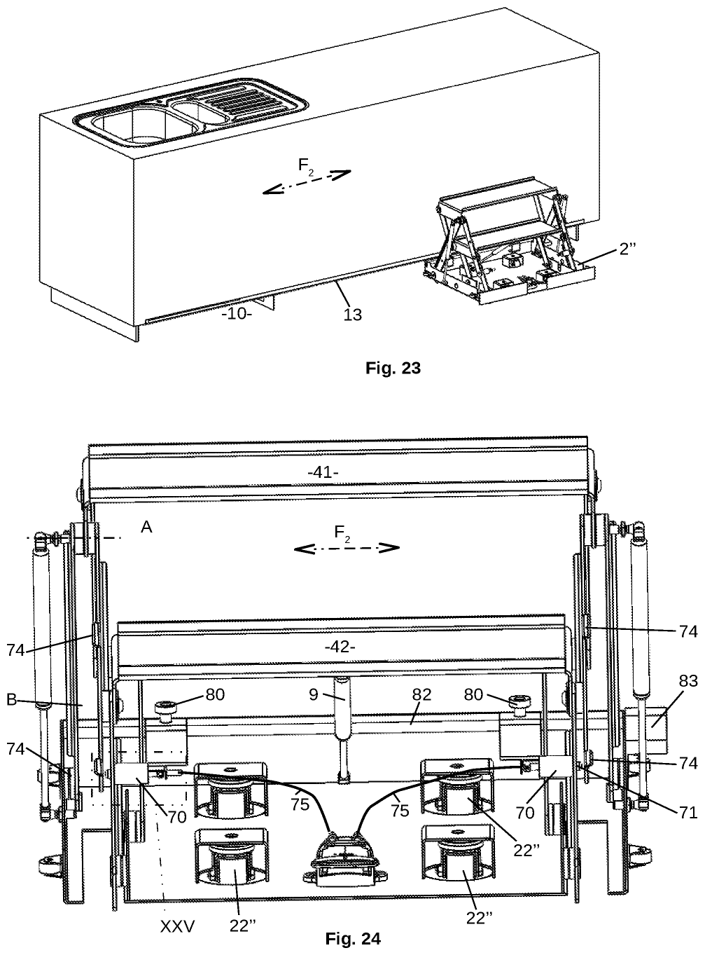

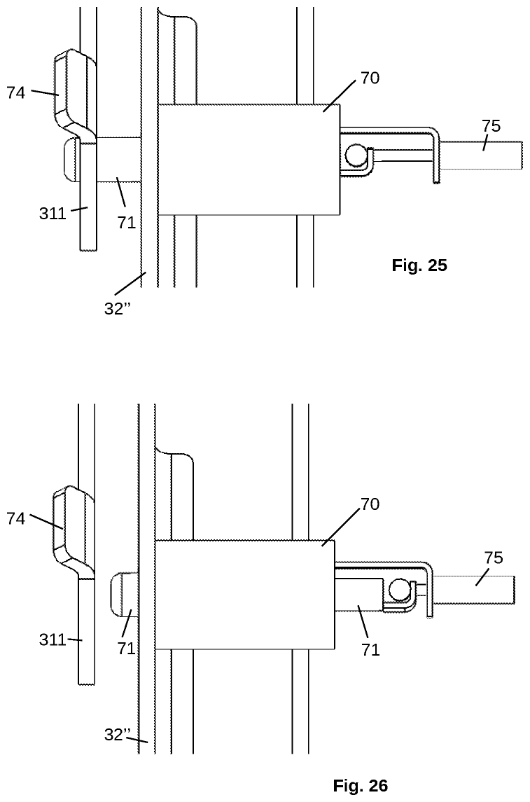

In a third embodiment, shown in FIGS. 16 to 26, the device differs from that of the first embodiment in that it does not include a retainer bar, a first gas spring or stop mechanism, but instead it comprises a locking mechanism 7 arranged to link together, in the deployed position and in the retracted position, the first and the second link bars 31″, 32″. The device is shown in the figures without the third board, to facilitate comprehension.

The locking mechanism 7 comprises a body 70 fixed onto the second link bar 32″, the first link bar 31″ comprising an arm 311 extending the first link bar 31 beyond the pivot axis B between the two link bars 31″, 32″, the locking mechanism 7 further comprising a latch bolt 71 mounted slidingly and elastically in the body 70 and arranged to cooperate with a first strike plate 72 on the arm 311 and a second strike plate 73 on the first link bar 31 opposite the first strike plate 72 relative to said pivot axis. Here, the latch bolt 71 is in the shape of a rod and the strike plates are circular holes. The first link bar 31 further comprises two guide ramps 74 designed to retract the latch bolt 71 during the relative pivoting of the link bars facing each of the strike plates.

The locking mechanism 7 is remotely controlled by an actuating member, such as a pedal 24″. The pedal 24″ is connected by brake cables 75 to each of the locking mechanisms 7 so that the latch bolt 71 is withdrawn from the strike plate against the elastic means in order to release the link bars.

The device further comprises a third gas spring 9 mounted pivotably firstly on the base frame at the rear and, secondly, on the second board 42. This third gas spring 9 serves to align the first and second link bars 31″, 32″ and engage the latch bolt 71 in the first strike plate 72.

In the retracted position, the first and the second link bars 31″, 32″ are stowed on top of each other and linked together by the locking mechanism 7 whose latch bolt 71 cooperates with the second strike plate 73, which holds the device in the retracted position. When the pedal 24″ is operated, the latch bolt 71 is released from the strike plate and the device is deployed under the effect of the second springs 5. In the movement, the guide ramp 74 opposite the first strike plate 72 causes the latch bolt 71 to retract, then the latter engages in the first strike plate 72, which locks the device in the deployed position. The return to the retracted position is achieved by operating the pedal 24″ to extract the latch bolt 71 from the first strike plate 72, and by pressing on the boards 41, 42 to compress the second gas springs 5 until the device is in the retracted position.

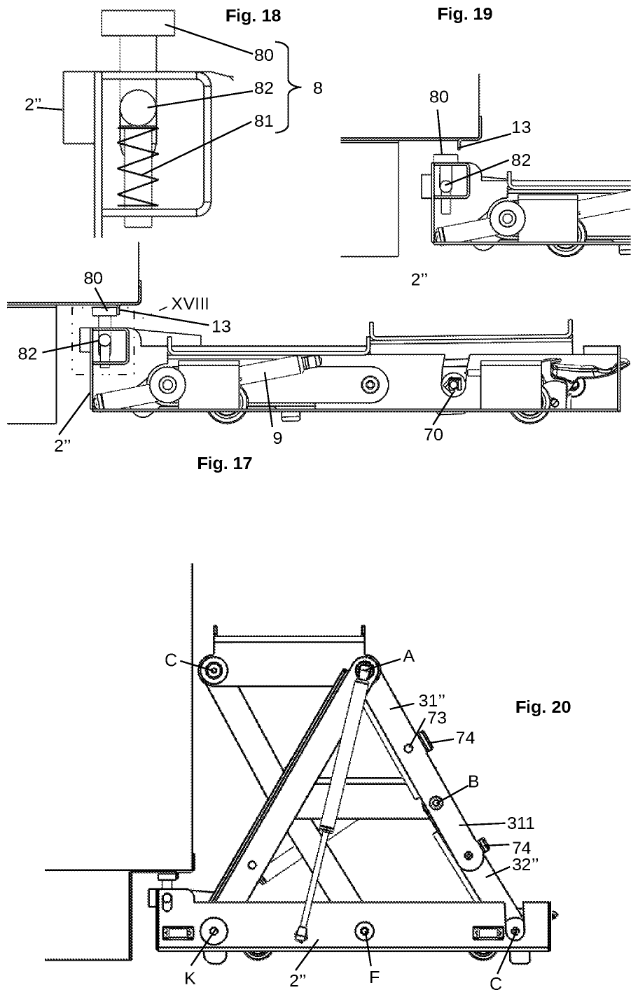

In this embodiment, the base frame 2″ comprises swivel castors 22″. It also comprises, at the rear, abutment means 8 extending substantially vertically and transversely. The abutment means 8 comprise two studs 80 mounted vertically slidingly and maintained in the upper position by springs 81. The studs 80 are linked to a transverse rod 82 fitted with a handle 83 at one end. The abutment means 8 are capable of engaging with a guide limb 13 fixed onto a surrounding structure to hold the device in the main direction and guide it transversely, as shown in FIGS. 17, 20 and 23.

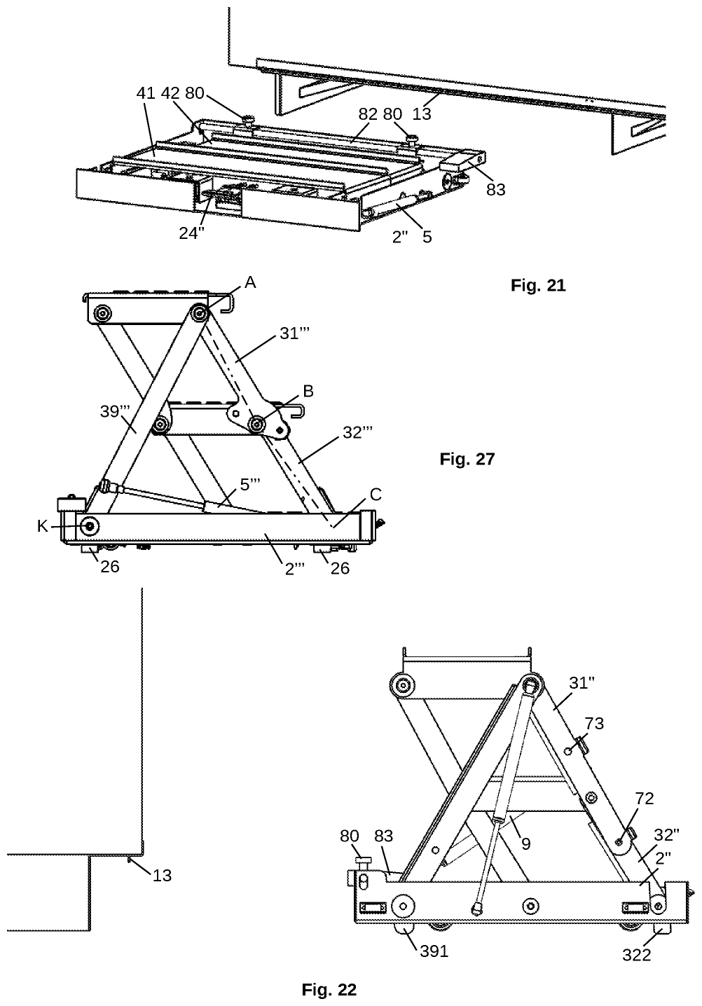

The abutment means 8 are retractable by pressing the handle 83 to slide the studs 80 downwards and release them from the guide limb 13. The device can then be moved freely on the floor, as shown in FIGS. 21 and 22.

In a version illustrated in FIG. 27, in the deployed position, the pivot axis B of the first link bar 31 on the second link bar 32′″ is offset towards the pivot axis K of the main bar 39′″ on the base frame 2′″ relative to the segment formed by the pivot axes A, C of the first link bar 31′″ on the main bar 39′″ and of the second link bar 32′″ on the base frame 2′″. In other words, in the polygon KABC, the angle ABC is a re-entrant angle, whereas the others are salient angles. This means that it is enough to press on the first step 41 to obtain the movement of the subassemblies towards the retracted position, after unlocking link bars 31′″, 32′″.

Independently of this particularity, the second gas springs 5′″ are positioned in a specific way. The anchor point on the base frame 2′″ is situated near the pivot axis of the second link bar 32′″ and the anchor point on the main bar 39′″ is at a distance of between ⅛ and ¼ inclusive of the length of the main bar 39′″ from the pivot axis K of the main bar 39′″ on the base frame 2′″.

In an embodiment not illustrated, the device is a display unit designed to be fixed to the top of a cabinet, mobile or fixed, or to the inside of a drawer, and the boards are in the form of shallow trays to serve as containers. Such a device does not comprise blocking or locking means, stability in the deployed position being provided by the effect of the springs. Maintaining in the retracted position can be achieved by the stop mechanism, or by an equivalent mechanism holding a cover over the device.

The invention is not limited to the embodiments described, which are provided only by way of examples. The abutment means could be used with the second embodiment. In the case where the device is attached to a “ceiling”, it is not necessary to use springs to achieve deployment or a system of blocking in the deployed position, as this position is naturally stable due to gravity. The gas springs can be replaced by other types of springs, for example torsion springs placed at the pivot axes, or compression springs or helical tension springs. The locking mechanism could be used to link the third and the fourth link bars. It is possible to fit only three castors.

1. A device deployable from a retracted position to a deployed position, comprising at least a first board and a second board, the first and the second boards extending into the deployed position in a first horizontal plane and a second horizontal plane respectively, the two planes being offset from each other, said device comprising a base frame designed to be horizontal and a deployment mechanism comprising two subassemblies on either side of the boards to guide the boards between the retracted position and the deployed position, and vice versa, the first board being offset towards the rear of the device relative to the second board in a horizontal main direction when the device is in the deployed position, wherein, when the device is in the retracted position, the first board is offset towards the front of the device and the second board is offset rearwardly, the two boards being situated at substantially the same level and parallel to the first and the second planes (P, P′), the base frame and being detached, fixed or connected to a surrounding structure by at least one horizontally extending telescopic arm.

2. The device according to claim 1, wherein each subassembly comprises a main bar mounted pivotably on the base frame towards the rear, a first support bar to support the first board and mounted pivotably at the top end of the main bar, a first link bar mounted pivotably also at the top end of the main bar, and a second link bar in alignment with the first link bar in the deployed position and mounted pivotably on the base frame towards the front.

3. The device according to claim 2, wherein, in the deployed position, the pivot axis (B) of the first link bar on the second link bar is offset towards the pivot axis of the main bar on the base frame relative to the segment formed by the pivot axes of the first link bar on the main bar and of the second link bar on the base frame.

4. The device according to claim 2, wherein the subassembly further comprises a second support bar to support the second board, parallel to the first support bar and mounted pivotably on the first link bar on the same axis as the second link bar, and a third link bar parallel to the first link bar and linked pivotably to the first and the second support bars, so that the pivot axes of the first and the third link bar are positioned in the corners of a first parallelogram.

5. The device according to claim 4, wherein the subassembly further comprises a fourth link bar parallel to the second link bar and linked pivotably to the second support bar and to the base frame so that the pivot axes of the second and the fourth link bars are positioned in the top corners of a second parallelogram.

6. The device according to claim 5, wherein the subassembly further comprises a retainer bar mounted pivotably on the second support bar at one end and mounted slidably and pivotably at the second end on the base frame in the horizontal main direction so as to form a blocking strut for the second support bar in the deployed position by being close to vertical.

7. The device according to claim 6, wherein the retainer bar is connected to a first gas spring connected to the base frame and serving to move the sliding end of the retainer bar towards the blocking strut position.

8. The device according to claim 7, wherein the retainer bar comprises a pivot pin guided in a runner on the base frame, said runner comprising a notch in which the pivot pin is lodged in the deployed position by a downward movement of the retainer bar, so that it prevents the pivot pin sliding in the runner when there is a load on one or other of the boards.

9. The device according to claim 8, wherein the first gas spring includes blocking means to block the rod of the first gas spring in the extended position and prevent the pivot pin sliding in the runner in the deployed position, and tensioning means that push the retainer bar upwards so that it tends to push the pivot pin away from the notch.

10. The device according to claim 5, wherein the parts of a subassembly of the deployment mechanism are arranged in a transverse direction, that is to say horizontally and perpendicular to the main direction, as follows, from the outside inwards:
the main bar;
the first support bar;
the third link bar;
the first link bar;
the second link bar, mounted pivotably on the outside of a vertical flange on the base frame;
the second support bar;
the fourth link bar, mounted pivotably on the inside of the vertical flange on the base frame.

11. The device according to claim 6 taken in combination, wherein the retainer bar is placed after the fourth link bar.

12. The device according to claim 2, wherein each subassembly includes a second gas spring connecting the base frame and the main bar and serving to place the device in the deployed position.

13. The device according to claim 12, wherein the second gas spring is connected to the main bar close to the top end of the main bar.

14. The device according to claim 2, wherein the main bar comprises a first heel extending the main bar beyond the pivot axis on the base frame so that the first heel protrudes underneath the base frame when the device is in the deployed position to rest on the floor, and retracts in the retracted position.

15. The device according to claim 2, wherein the second link bar comprises a second heel extending the second link bar beyond the pivot axis on the base frame so that the second heel protrudes underneath the base frame when the device is in the deployed position to rest on the floor, and retracts in the retracted position.

16. The device according to claim 14, wherein a shoe is interposed between the first or the second heel.

17. The device according to claim 2, wherein it comprises a locking mechanism arranged to link together, in the deployed position and in the retracted position, the first and second link bars or the third and fourth link bars.

18. The device according to claim 17, wherein the locking mechanism comprises a body fixed onto one of the first or second link bars, the other link bar comprising an arm extending said link bar beyond the pivot axis between the two link bars, the locking mechanism further comprising a latch bolt mounted slidingly and elastically in the body and arranged to cooperate with a first strike plate on the arm and a second strike plate on the other link bar opposite the first strike plate relative to said pivot axis.

19. The device according to claim 17, wherein the locking mechanism, is remotely controlled by an actuating member.

20. The device according to claim 2, wherein the device comprises a stop mechanism arranged to link together the second or first board and the base frame in the retracted position.

21. The device according to claim 1, wherein the base frame comprises swivel castors and, at the rear, abutment means extending substantially vertically and transversely, said abutment means being capable of engaging with a guide limb fixed onto a surrounding structure to hold the device in the main direction and guide it transversely.

22. The device according to claim 21, wherein the abutment means are retractable.

23. The device according to claim 1, wherein the base frame comprises castors on which the device can be moved, said castors being retractable so that the device rests on the floor on fixed pads when a weight is resting on the device.
